(19) United States
(12) Patent Application Publication
(10) Pub. No.: US 2016/0267539 A1
(43) Pub. Date: Sep. 15, 2016

(54) Individual And Fleet-Based Vehicle-Based Wireless Marketing Device

(71) Applicant: My Logoes, Inc., Darien, CT (US)

(72) Inventor: Faris Mousa Saah, Darien, CT (US)

(21) Appl. No.: 14/514,727

(22) Filed: Oct. 15, 2014

(51) Int. Cl. G06Q 30/02; G06Q 20/10; H02J 7/35; H04W 4/00

(52) U.S. Cl. CPC G06Q 30/0265; H04W 4/008; G06Q 20/10; H02J 7/35; H04M 2250/02

(57) ABSTRACT

A battery- or solar-powered wireless removable device fixed to the outside of a motor vehicle for the purpose of promoting a product and/or a service. The product and/or service is normally one produced and sold by an enterprise (e.g. McDonalds, Nike, AT&T). Each device in service is registered to the vehicle's owner and/or operator for the purpose of compensating the owner and/or operator for displaying the device for an agreed upon compensation and period of time. The location and journey of the motor vehicle as well as the duration of display of the device is actively trackable by the sponsoring enterprise. This is made possible through the BLUETOOTH™ (or other low power wireless technology) connectivity of the device to a tracking system via a wireless communications device in the vehicle. The vehicle owner/operator may enter into multiple contracts with multiple enterprises (or their agents) and therefore attach multiple devices to his/her vehicle and be compensated for displaying each device. A computer-, smart phone- or tablet-based application can be used to manage the vehicle owner/operator's portfolio of devices, contracts and compensation.

### CROSS REFERENCE RELATED APPLICATIONS

I hereby claim benefit under Title 35, United States Code Section 119(e) of the U.S. provisional patent application Ser. No. 62/042,731 filed Aug. 27, 2014. The 62/042,731 application is currently pending and is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention pertains generally to battery- or solar-powered, attachable/detachable wireless promotional devices affixed to the outside of a motor vehicle for the purpose of promoting a product and/or service. More specifically, the invention pertains to a powered, wireless device (magnetic or otherwise affixable to a vehicle's exterior) displaying a corporate logo and/or slogan (e.g. McDonalds' “i'm lovin' it”, or Nike's “Just Do It”.). The owner and/or operator of the vehicle displaying the device, as well as the device itself, are registered with the sponsoring enterprise (or their agent) so that the displaying person(s) can receive compensation for displaying the device. The vehicle owner/operator can manage his/her portfolio of devices and advertising contracts through a software application available on a desktop computer, smart phone or tablet device.

2. Description of Related Art

Many devices and approaches have been developed in the past to enable commercial enterprises to promote their products or services on moving vehicles. U.S. Patent Application No. 2004/0267617 filed for Yanase is directed to a method and system for charging a vehicle advertisement rate. This method and system is a vehicle advertisement service using public transportation such as buses or trains, which travel regular routes, through having advertisement on the external body parts. In an advertising vehicle, vehicle sensors are mounted for detecting the traveling state such as (i) the traveling speed and (ii) the traveling position, and an on-vehicle terminal is mounted for importing the information detected by the sensors. The traveling state information is imported to a vehicle-state collecting server from the on-vehicle terminal through a network. An advertisement rate calculating server calculates the advertisement rate from the traveling state information and data of an advertisement rate system stored beforehand in which unit rates per traveling distance, changing ratio of the unit rates according to the traveled unit area and the like are collected. Then, the information on the advertisement rate and the traveling state information are transmitted to the advertiser terminal.

U.S. Pat. No. 5,825,281 issued to McCreary is directed toward a method of displaying advertising messages. A message to be displayed is sent to the display device from an onboard processor, having been retrieved from memory. The message comes on with the automotive brake lights and remains on until the brakes are released. The message changes with each application of the brake lights and is a continuous loop of sequentially displayed messages. In an alternative embodiment, the display remains on in a dimmer mode until the next application of the brakes changes the message. Thus, the message may be displayed while brake lights are energized, or alternatively, once brake lights are extinguished the message goes to a tail light mode having a reduced illumination level, for example, half as bright.

U.S. Patent Application No. 2007/0118423 filed for Always is directed to a method and system for generating an income stream from advertising including a display device mounted on a vehicle. The vehicle owner or lessee will receive an incentive from an advertiser or seller to mount the display device to the vehicle in the form of a payment for a specified period of time. The income stream may be a contribution to the vehicle down payment, periodic vehicle payment or periodic insurance payment made by the advertiser. The display device may be mounted on the rear of the vehicle including an illuminating device wired to the electrical system of the vehicle. The display device may be used in connection with a telephone number or Internet web location to provide a viewer with additional information provided by the advertiser.

In 1990, The U.S. Patent Office issued U.S. Pat. No. 4,928,084 to Reiser, whose invention is directed toward a combined message display and brake light. His system employs a display containing LED lights, that when activated, transmit a message or pattern in red light. The device has either a fixed or programmable memory which holds data which can be selectively extracted to activate select diodes that convey a single line message. When the brake pedal of the car, where the system is mounted, is depressed, all of the diodes are activated to produce a solid display of red over the entire screen. As a safety precaution, the diodes remain inactive until the brake pedal is depressed and from then on each subsequent depression of the brake pedal produces a solid display of red over the entire screen.

U.S. Pat. No. 8,543,133 issued to Pomerantz, et al, is directed toward a method and apparatus for locating the position of a mobile device in an assisted satellite positioning system. In one example, satellite measurement data is obtained from a plurality of satellites at a mobile device. Position of the mobile device is computed using the satellite measurement data. The position is sent to a cellular device via a wireless ad hoc network. In one embodiment, the wireless ad hoc network comprises a BLUETOOTH™ communication link. In one embodiment, the mobile device is configured to receive assistance data from a position server through the wireless ad hoc network. The mobile device may comprise a housing configured to plug into a cigarette lighter connector of an automobile and the cellular device may comprise a cellular telephone without location-determination capabilities (i.e., the cellular telephone does not include an integrated GPS receiver.).

U.S. Pat. No. 7,102,510 issued to Boling, et al, is directed to an invention that provides an asset location tracking system for tracking the position of a mobile asset, such as an automobile, boat or airplane. The tracking system includes a mobile unit for installation in the mobile asset. The mobile unit includes a position locating unit, such as a GPS unit, for generating position information indicative of the position of the mobile asset and a wireless transmitter, such as a cellular transmitter, for wirelessly transmitting the position information. In preferred embodiments, the position information is displayed as a graphical indicator, such as a “push pin” on a map or aerial photograph displayed on a webpage accessed by a customer computer.

U.S. Pat. No. 7,143,533 issued to Burke is directed toward a method and apparatus for controlling and managing the display of decals, stickers, placards, or similar items affixed to decal display plates so that they may be exposed when the car is parked and removed from view when the vehicle is being operated and vice-versa. In preferred embodiments, the display system will comprise a single or multiple decal display plates upon which decals, stickers, labels, placards, or similar items may be affixed and housed with single or multiple housing units. The location of these decal plate housing units will be within the interior of the motor vehicle and near those areas of the windows of a motor vehicle which have traditionally been used to display decals, stickers, labels, placards or similar items (e.g.: the edges of the front windshield, particularly the corners thereof; the edges of the rear window, particularly the corners thereof; the forward-facing surface of the rear view mirror; and such other places as may be deemed appropriate for display of decals, stickers, labels, placard or similar items).

Commercial enterprise is the backbone of the American economy. The commerce cycle often begins with consumers identifying in themselves a need for a product or service. Existing companies or new market entrants recognize this consumer need and produce, market and sell the product or service that is desired. The primary means by which these producers raise awareness of their products or services is through display advertising. For display advertising to be effective, it must, among other things, be positioned in view of potential customers' eyes. Ideally, for the producer, the advertising images are kept in front of customer eyes for long and sustained periods of time. This, however, is often difficult to accomplish, as consumers have multiple means by which they can by-pass or avoid looking at display advertising.

What is needed, therefore, is a method and device to allow companies, selling a product or service, to display their advertising in as sustained and ubiquitous a manner as possible. Given the integral role that cars and trucks play in our everyday lives and hence their ubiquity, they represent ideal platforms to display corporate advertising. It is therefore an objective of the present invention to provide a wireless device, affixable to the outside of a motor vehicle, for the purpose of promoting a product and/or service. It is further an objective of this invention to provide a method for (i) registering the device; (ii) registering the owner/operator of the vehicle; (iii) tracking the location and journey of the vehicle; (iv) compensating the owner/operator for displaying the device and (v) enabling the owner/operator to manage his/her portfolio of devices through an Internet-based application (accessible through a desktop computer, smart phone, tablet, or other electronic communications device).

Prior art creates situations where the vehicle owner/operator must connect any display advertising device into the vehicle's own electrical system and in some cases, connect it directly to the braking system in order to manage image display. In addition, prior art does not provide a means for a vehicle owner/operator to display multiple advertisements and hence receive compensation from multiple commercial enterprises (or their agents). Finally, prior art does not provide a means for the sponsoring enterprise to track the location and journey of the motor vehicle or the duration of display of the device, and hence track compliance with the display agreement. It is to these failures of the prior art, among others, to which this present invention is drawn.

### SUMMARY OF THE INVENTION

The present invention provides a device and method for commercial enterprises to place display advertisements onto the outside of moving vehicles and to compensate the vehicles' owners/operators for displaying the advertisements. The display advertisement itself is printed onto the device which is magnetically (or otherwise) affixable to the outside of a motor vehicle. The device housing is manufactured to include magnets so that the housing adheres to the metallic outside body of a motor vehicle.

The device includes a power source (either in the form of a battery or photovoltaic cells) in order for the device to communicate wirelessly (via BLUETOOTH™) with a vehicle-based communications device such as the operator's cell phone, an in-vehicle satellite radio antenna or the vehicle's own on-board cellular communications system. The device will be BLUETOOTH™ enabled to support wireless communications between the device and any vehicle-based communications devices.

In a variant of the invention, the device will be given to and registered to a vehicle owner or operator. The registration process will encompass a contract between the advertising (sponsoring) enterprise and the vehicle owner/operator (the display agreement) whereby the sponsoring enterprise agrees to compensate the vehicle owner/operator for displaying the device and the vehicle owner/operator agrees to display the device on their vehicle for an agreed-upon period of time. The device's activation, location and journey are tracked by the sponsoring enterprise to ensure owner/operator compliance with the terms of the display agreement.

In another variant, the compensation is an electronic payment to the registered owner/operator's bank account. In still another variant, the compensation is a credit given to the owner/operator to be used specifically for the purchase of the sponsoring enterprise's own goods and/or services. And in yet another variant, the compensation is a credit given to the owner/operator for the purchase of a third party's goods and/or services. Compensation can be in the form of currency, store credit, frequent flier miles, hotel points, etc.

Additionally, the wireless vehicle device system will provide a method and system for registering each and every device with the sponsoring enterprises, their agents and the vehicle owners/operators displaying each device.

In the preferred embodiment the advertising device is affixed to the rear panel of the vehicle. As the vehicle owner/operator drives the vehicle, the location and journey of the device is tracked by the advertising enterprise. At pre-determined intervals of time, the vehicle owner/operator will receive compensation from the enterprise for displaying the device.

In this respect, before explaining at least one embodiment of the invention in detail it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of the invention, illustrating the wireless marketing device mounted to the rear of a vehicle, communicating wirelessly to and through a vehicle-based communications systems to the sponsoring enterprise or its agent.

FIG. 2 is a front-facing perspective view of the invention in one embodiment where the wireless marketing device is imprinted with the sponsoring enterprise's logo.

FIG. 3A is a side-facing perspective view of the invention illustrating the casings containing the BLUETOOTH transmitter, the battery and the magnetic striping.

FIG. 3B is a rear-facing perspective view of the invention illustrating the casings containing the BLUETOOTH transmitter, the battery and the magnetic striping.

### DETAILED DESCRIPTION OF THE PREFERRED EMBODIMENT

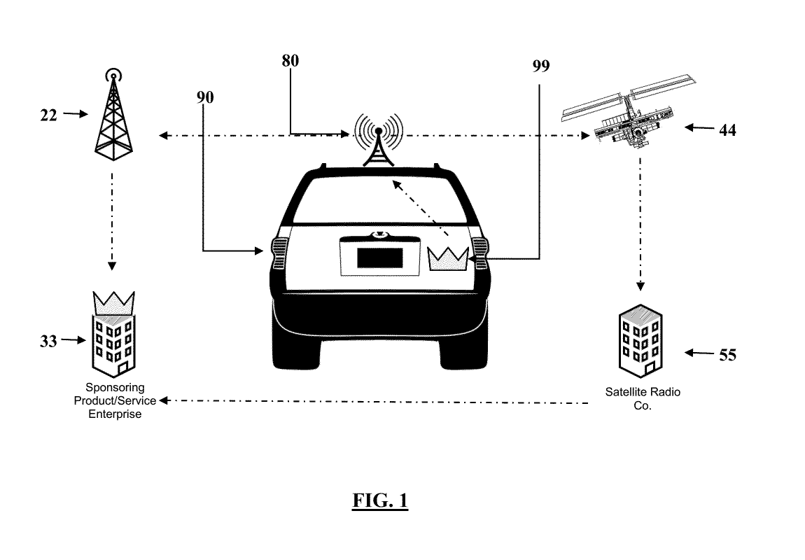

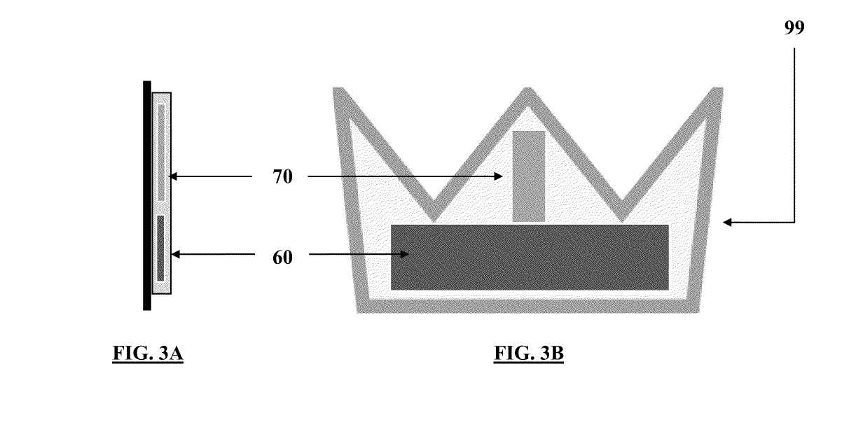

FIG. 1 is a system-functional diagram showing a vehicle-based wireless marketing device 99 attached to the rear panel of an automobile 90. This device 99 is observable by any person facing the vehicle's rear. The device 99 is attachable to and removable from the vehicle 90. This is enabled through magnets embedded in the device's housing (see FIG. 3A and FIG. 3B). The device 99 is printed with the logo 98 of the sponsoring enterprise 33. In the example shown in FIG. 1, the logo 98 is “King of Burgers”. The device 99 is equipped with both a power source and BLUETOOTH™ transmitter/receiver (see FIG. 3A and FIG. 3B).

Once produced and available for distribution, the device 99 is given to and registered to the vehicle owner/operator. This can be accomplished in a number of ways, including but not limited to, distribution through the mail (USPS, FedEx, UPS, etc), distribution through retail outlets, or distribution through third parties (distributors, aggregators, marketing firms, etc.). The vehicle owner/operator interested in entering into a display advertising agreement with the sponsoring enterprise, will request a marketing device 99 to be given to and registered to him/her either in person, via the internet or by telephone.

In one embodiment, after receipt of the device 99, the vehicle owner/operator affixes it to the rear panel of his/her automobile 90. The device 99 will send identifying data wirelessly to a vehicle-based wireless communication system 80. This system could be the vehicle operator's cell phone, an in-vehicle satellite radio antenna or the vehicle's own on-board cellular communications system. From there, the device-specific identifying information is sent to the sponsoring enterprise 33 (or its agents) via satellite radio systems 44 or through traditional 4G cellular phone networks 22.

The sponsoring enterprise 33 receives the device-specific information along with its location and journey information and uses that data to generate compensation for the specific device 99 holder. In an exemplary embodiment, the sponsoring entity compensates the device 99 holder with a hard currency credit to his/her checking or savings account. Variants of this embodiment would include compensation to the device holder to his/her chosen value-storing debit card, Apples iTunes account, credit card account, sponsoring entity smart card (e.g. Starbucks Card).

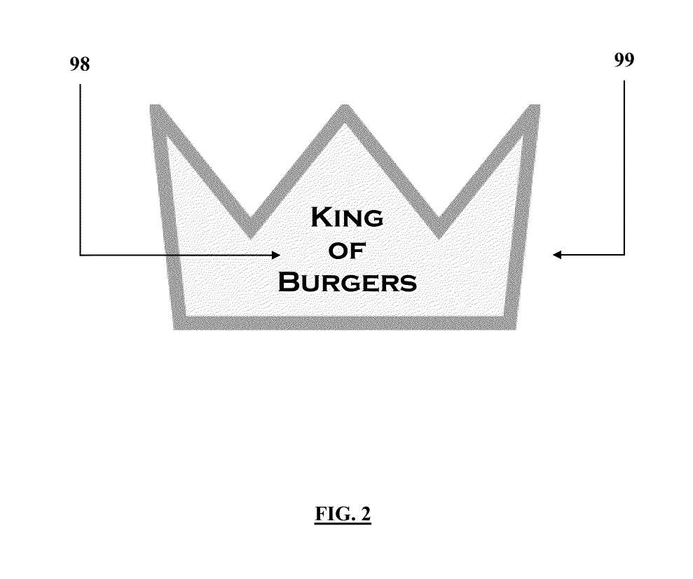

FIG. 2 shows a preferred embodiment of the display advertising device 99 with a corporate (sponsoring enterprise's) corporate logo printed on it 98. The device 99 can bear any of a number of corporate slogans and/or logos. In one exemplary embodiment, the device 99 displays a corporate logo as in the Nike “Swoosh” [symbol] . In this embodiment, the vehicle owner/operator will place the Nike Swoosh-printed device 99 on the rear of her vehicle 90. She will have registered it with Nike and Nike (or its agent) will track the device's 99 location and journey. After a defined period of time, Nike will compensate the device holder (owner/operator) by mailing her a Nike Card with a credit balance to be spent in a Nike retail store or with an online retailer accepting the card as payment.

FIG. 3A is a side-view of the device 99 showing the location, within the device housing, 99 of the BLUETOOTH™ transmitter/receiver 70 and the power source 60. In one embodiment, the device will be equipped with a battery which will enable the BLUETOOTH™ device to communicate wirelessly with the vehicle-based wireless communication system 80. This system could be the vehicle operator's cell phone, an in-vehicle satellite radio antenna or the vehicle's own on-board cellular communications system. In this embodiment, the battery will be rechargeable by the device manufacturer, the device distributor and the ultimate device holder (the vehicle owner/operator). Another embodiment would provide a power source via photovoltaic cells placed on the outside of the display advertising device 99 such that solar power will enable the BLUETOOTH™ device to communicate wirelessly with the vehicle-based wireless communication system 80

FIG. 3B is a rear-view of the device 99 showing the location, within the device housing, 99 of the BLUETOOTH™ transmitter/receiver 70 and the power source 60. In one embodiment, the device will be equipped with a rechargeable battery which will enable the BLUETOOTH™ device to communicate wirelessly with the vehicle-based wireless communication system 80. This system could be the vehicle operator's cell phone, an in-vehicle satellite radio antenna or the vehicle's own on-board cellular communications system. In this embodiment, the battery will be rechargeable by the device manufacturer, the device distributor and the ultimate device holder (the vehicle owner/operator). Another embodiment would provide a power source via photovoltaic cells placed on the outside of the display advertising device 99 such that solar power will enable the BLUETOOTH™ device to communicate wirelessly with the vehicle-based wireless communication system 80.

In summary, this invention discloses a battery- or solar-powered, attachable/detachable, wireless marketing device affixable to the outside of a motor vehicle for the purpose of promoting a product and/or a service. It also discloses a system and method for registering the device, tracking its location and journey and compensating the device holder (vehicle owner/operator) for displaying the device as agreed.

It will be appreciated that the invention has been described hereabove with reference to certain examples or preferred embodiments as show in the drawings. Various additions, deletions, changes and alterations may be made to the above-described embodiments and examples without departing from the intended spirit and scope of this invention. Accordingly, it is intended that all such additions, deletions, changed and alterations be included within the scope of the following claims.

Although the present invention has been described in terms of the presently preferred embodiment, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

Having now described the features, discoveries, and principles of the invention, the manner in which the battery- or solar-powered vehicle-based wireless marketing device is constructed and used, the characteristics of the construction, and the advantageous new and useful results obtained; the new and useful structures, devices, elements, arrangements, parts, combinations, and methods are set forth in the appended claims.

I claim:

1. A powered wireless removable marketing device fixed to the outside of a motor vehicle for the purpose of promoting a product and/or a service.

2. The powered wireless device of claim 1 further comprising a rechargeable battery allowing the device to be charged and recharged by the device manufacturer, the device distributor and/or the ultimate device holder (the vehicle owner/operator)

3. The powered wireless device of claim 1 further comprising a photovoltaic cell or other means of converting solar rays into solar power for the purpose of providing power to the device.

4. The powered wireless device of claim 1 further comprising a magnetized housing making the device attachable to and detachable from a metallic-bodied vehicle.

5. The powered wireless removable device of claim 1 further comprising a BLUETOOTH™ transmitter/receiver enabling the device to communicate wirelessly to a vehicle-based wireless communication system.

6. A system and method for registering the display marketing device as being in the possession of the device holder and as being sponsored by the sponsoring enterprise.

7. The system and method of claim 6 further comprising a system for the sponsoring entity (owner of the marketed logo or slogan) to enter into a display marketing agreement with the registered device holder (vehicle owner/operator).

8. A system and method for tracking the location and journey of the registered display marketing device.

9. The system and method of claim 8 further comprising a system, employing the vehicle operator's cell phone, an in-vehicle satellite radio antenna or the vehicle's own on-board cellular communications system, to wirelessly communicate the location and journey of the device to the sponsoring enterprise and/or its agent(s).

10. A system and method for compensating the registered device holder for displaying the device as contracted.

11. The system and method of claim 10 further comprising a system for enabling the registered device holder to manage his/her portfolio of registered devices—either through a desktop computer, smart phone or tablet device.

12. The system and method of claim 10 further comprising a system for enabling the registered device holder to manage his/her portfolio of display marketing agreements entered into with each sponsoring entity.

13. The system and method of claim 10 further comprising a system for compensating the registered device holder for completion of agreement-based commitments (i.e. displaying the device for a defined period of time).
The system and method of claim 10 further comprising a system for compensating the registered device holder in a number of ways including (i) cash payments to his/her savings or checking account; (ii) credit to one of his/her unaffiliated credit cards; (iii) credit to one of his/her sponsor-affiliated credit cards; and (iv) credit to his/her sponsor-specific smart cards (e.g. Starbucks Card).
